(19) United States
(12) Patent Application Publication
(10) Pub. No.: US 2014/0327779 A1
(43) Pub. Date: Nov. 6, 2014

(54) METHOD AND APPARATUS FOR PROVIDING CROWDSOURCED VIDEO

(71) Applicant: Nokia Corporation, Espoo (FI)

(72) Inventors: Antti Eronen, Tampere (FI); Juha Arrasvuori, Tampere (FI); Jukka Holm, Tampere (FI); Arto Lehtiniemi, Lempaala (FI)

(73) Assignee: Nokia Corporation, Espoo (FI)

(21) Appl. No.: 13/874,869

(22) Filed: May 1, 2013

(51) Int. Cl. H04N 7/18

(52) U.S. Cl. CPC H04N 7/181
USPC 348/159

(57) ABSTRACT

A method, apparatus and computer program products are provided for providing video data. One example method includes receiving sensor data from one or more mobile terminals, analyzing the sensor data to determine whether to utilize video data captured by or able to be captured by at least one mobile terminal, and generating video content comprising video data captured by at least one mobile terminal. The video content may be a real time video broadcast, comprising live or near live data during one or more periods of time when a mobile terminal is able to capture a target and previously recorded video data of one or more events during one or more periods of time when a mobile terminal is not capturing the target.

### TECHNOLOGICAL FIELD

Embodiments of the present invention relate generally to a method, apparatus, and computer program product for providing crowdsourced video.

### BACKGROUND

At public events, such as sporting events, parades or the like, it is increasingly popular for users to capture these public events using a camera equipped mobile device. It is also increasingly popular for users to watch video content on their mobile devices. Many users capture video with mobile devices during live events which are happening along a route, such as for example a rally or motorcycle competition. However, currently there does not exist a solution for allowing other users to experience the near live video footage captured by users along the route of the competition or event.

### BRIEF SUMMARY

A method, apparatus and computer program product are therefore provided according to an example embodiment of the present invention to provide video to one or more mobile terminals, the video generated from video captured by one or more mobile terminals positioned such that, different views and times of a target may be recorded. The method, apparatus and computer program product may provide a service for providing near-live video streams from events which happen along a route. The service may be used as a standalone service for crowdsourcing video streams from sports events, or alongside a professional broadcast to provide additional amateur content from an alternate angle.

A mobile terminal may be configured for one or more of (1) capturing video; (2) capturing sensor data (e.g., compass data, Global Positioning System (GPS) location data, and accelerometer data, and/or gyroscope data); (3) transmitting sensor data; (4) transmitting video data; and (5) streaming video from a service. A service may be configured for one or more of (1) receiving video streams from one or more mobile terminals; (2) creating a video stream for mobile terminals; (3) selecting which video stream received will be used in the created video stream; and (4) utilizing map data and/or connecting to a map service.

FIG. 7 shows an example embodiment where cameraman 1 710, cameraman 2 715 and cameraman 3 720, each utilizing a mobile terminal, for example as described above, are positioned along a track where a car 705 is racing. As can be seen, when the car 705 is positioned such that cameraman 1 710 is positioned to capture video, the mobile terminal of cameraman 1 captures video of the car 705, while cameraman 2 715 and cameraman 3 720 receive video data on their mobile terminals showing the video data that cameraman 1 710 is capturing using his mobile terminal. The service, utilizing sensor data and/or video data, analyzes the data from cameraman 1 710, receives the video data and provides a video broadcast to the other mobile terminals. When the car 705 reaches a position where no cameraman is positioned 725 to record video with a mobile terminal, the service provides previously recorded video. When the car 705 reaches a position on the track where cameraman 2 715 is able to capture video of the car 705, his mobile terminal will transmit the captured video to the service, and the service may provide a video broadcast showing the video data captured by the mobile terminal of cameraman 2 715.

In one embodiment of the present invention, a method is provided comprising receiving sensor data from one or more mobile terminals, analyzing the sensor data to determine whether to utilize video data captured by or able to be captured by at least one mobile terminal, and causing transmission of an instruction to the mobile terminal to capture video during a particular time frame, and causing generation of video content comprising video data captured by at least one mobile terminal, wherein the generated video content comprises at least the video data captured during the particular time frame.

In one embodiment, analyzing the sensor data to determine whether to utilize video content associated with the sensor data, comprises identifying a target, and calculating a time of arrival of the target to a position in which a mobile terminal is able to capture video data of the target, the position determined by sensor data, wherein the particular time frame is related to the time of arrival of the target. In one embodiment, analyzing the sensor data to determine whether to utilize video content associated with the sensor data, comprises identifying an event, and determining at least one mobile terminal that captured the event based on the sensor data, and causing transmission of an instruction to the at least one mobile terminal to transmit video data related to the event during a particular time frame related to the time of arrival of the target, wherein the generated video content comprises video data of the event.

In one embodiment, the video content is a real time video broadcast, comprising live or near live data during one or more periods of time when a mobile terminal is able to capture the target and previously recorded video data of one or more events during one or more periods of time when a mobile terminal is not capturing the target. In one embodiment, sensor data comprises at least one of compass data, Global Positioning System (GPS) location data, and accelerometer data, gyroscope data, and audio data.

In another embodiment of the present invention, a method for use in a mobile terminal is provided, the method comprising causing capture of sensor data, causing transmission of sensor data, causing display of a video stream, receiving instructions indicating when to switch from a viewing mode to a capture mode, and causing transmission of captured video data. In one embodiment, the instructions comprise a time of arrival estimate, wherein the method further comprises, and causing display of a warning in advance of switching from the viewing mode to the capture mode. In one embodiment, the method may further comprise providing a signal indicating a manual switch from a viewing mode to a capture mode to be utilized in event detection. In one embodiment, the sensor data comprises at least one of compass data, Global Positioning System (GPS) location data, and accelerometer data, gyroscope data, and audio data.

In another embodiment of the present invention, an apparatus is provided. The apparatus comprising at least one processor and at least one memory including computer program code, the at least one memory and the computer program code configured to, with the processor, cause the apparatus to at least receive sensor data from one or more mobile terminals, analyze the sensor data to determine whether to utilize video data captured by or able to be captured by at least one mobile terminal, and cause transmission of an instruction to the mobile terminal to capture video during a particular time frame, and cause generation of video content comprising video data captured by at least one mobile terminal, wherein the generated video content comprises at least the video data captured during the particular time frame.

In one embodiment, analyzing the sensor data to determine whether to utilize video content associated with the sensor data, comprises identifying a target, calculating a time of arrival of the target to a position in which a mobile terminal is able to capture video data of the target, the position determined by sensor data, and wherein the particular time frame is related to the time of arrival of the target.

In another embodiment, analyzing the sensor data to determine whether to utilize video content associated with the sensor data, comprises identifying a target, calculating a time of arrival of the target to a position in which a mobile terminal is able to capture video data of the target, the position determined by sensor data, and wherein the particular time frame is related to the time of arrival of the target.

In one embodiment, the video content is a real time video broadcast, comprising live or near live data during one or more periods of time when a mobile terminal is able to capture the target and previously recorded video data of one or more events during one or more periods of time when a mobile terminal is not capturing the target. In one embodiment, the sensor data comprises at least one of compass data, Global Positioning System (GPS) location data, and accelerometer data, gyroscope data, and audio data.

In another embodiment of the present invention an apparatus is provided, the apparatus comprising at least one processor and at least one memory including computer program code, the at least one memory and the computer program code configured to, with the processor, cause the apparatus to at least cause capture of sensor data, cause transmission of sensor data, and cause display of a video stream, receive instructions indicating when to switch from a viewing mode to a capture mode, and cause transmission of captured video data.

In one embodiment, the instructions comprise a time of arrival estimate, wherein the method further comprises, causing display of a warning in advance of switching from the viewing mode to the capture mode. In one embodiment the at least one memory and the computer program code are further configured to, with the processor, cause the apparatus to provide a signal indicating a manual switch from a viewing mode to a capture mode to be utilized in event detection. In one embodiment, the sensor data comprises at least one of compass data, Global Positioning System (GPS) location data, and accelerometer data, gyroscope data, and audio data.

In another embodiment of the present invention, a computer program product comprising at least one non-transitory computer-readable storage medium having computer-executable program code portions stored therein, the computer-executable program code portions comprising program code instructions for receiving sensor data from one or more mobile terminals, analyzing the sensor data to determine whether to utilize video data captured by or able to be captured by at least one mobile terminal, and causing transmission of an instruction to the mobile terminal to capture video during a particular time frame, and causing generation of video content comprising video data captured by at least one mobile terminal, wherein the generated video content comprises at least the video data captured during the particular time frame.

In another embodiment of the present invention, a computer program product comprising at least one non-transitory computer-readable storage medium having computer-executable program code portions stored therein, the computer-executable program code portions comprising program code instructions for causing capture of sensor data, causing transmission of sensor data, and causing display of a video stream, receiving instructions indicating when to switch from a viewing mode to a capture mode, and causing transmission of captured video data.

In another embodiment of the present invention, a terminal apparatus (e.g., a mobile terminal) is provided. The terminal apparatus comprising a processor and a video display, the terminal apparatus configured for capturing video data; and displaying video data, the terminal apparatus comprising at least a video capturing mode and a video viewing mode, wherein a mode is changed based on a position of the terminal apparatus. In one embodiment, the terminal apparatus configured for transmitting video data, wherein the video capturing mode is configured for transmitting video data. In one embodiment, the terminal apparatus configured for receiving video data, wherein the video viewing mode is configured for receiving video data. In one embodiment, the terminal apparatus may be configured for capturing sensor data, transmitting the sensor data, and receiving information indicating a time for switching to the video capturing mode based on the sensor data.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is a block diagram of an apparatus that may be specifically configured in accordance with an example embodiment of the present invention.

FIG. 4 is an example flowchart illustrating a method of operating an example apparatus in accordance with an embodiment of the present invention;

FIG. 5 is an example flowchart illustrating a method of operating an example apparatus in accordance with an embodiment of the present invention;

FIG. 6 is an example flowchart illustrating a method of operating an example apparatus in accordance with an embodiment of the present invention; and

FIG. 7 is a diagram of an example embodiment of the present invention.

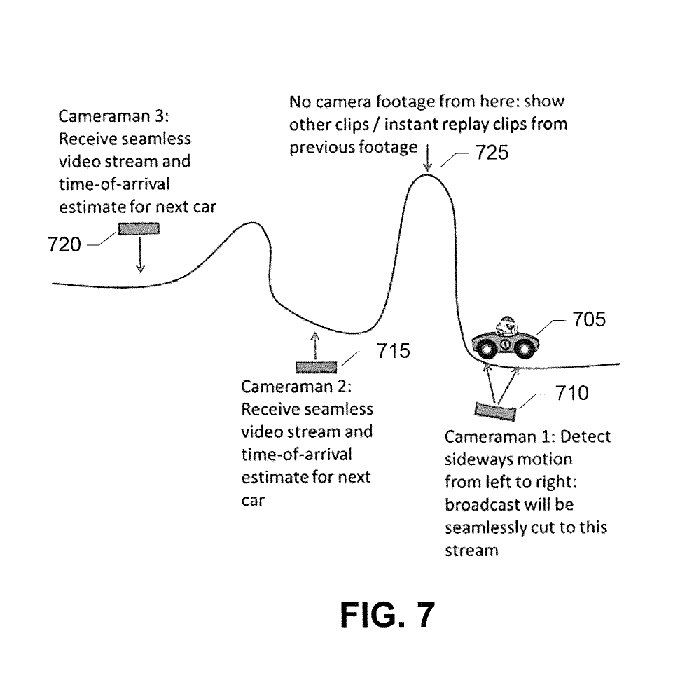

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

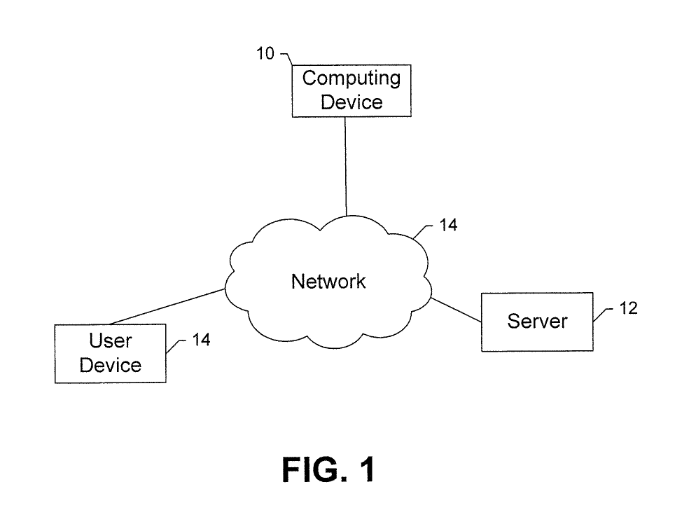

Referring now of FIG. 1, a system that supports communication, either wirelessly or via a wireline, between a computing device 10 and a server 12 or other network entity (hereinafter generically referenced as a “server”) is illustrated. As shown, the computing device and the server may be in communication via a network 14, such as a wide area network, such as a cellular network or the Internet or a local area network. However, the computing device and the server may be in communication in other manners, such as via direct communications between the computing device and the server.

The computing device 10 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device. The user device 14 may be embodied by a computing device, and in one embodiment, may be comprised of a plurality of computing devices.

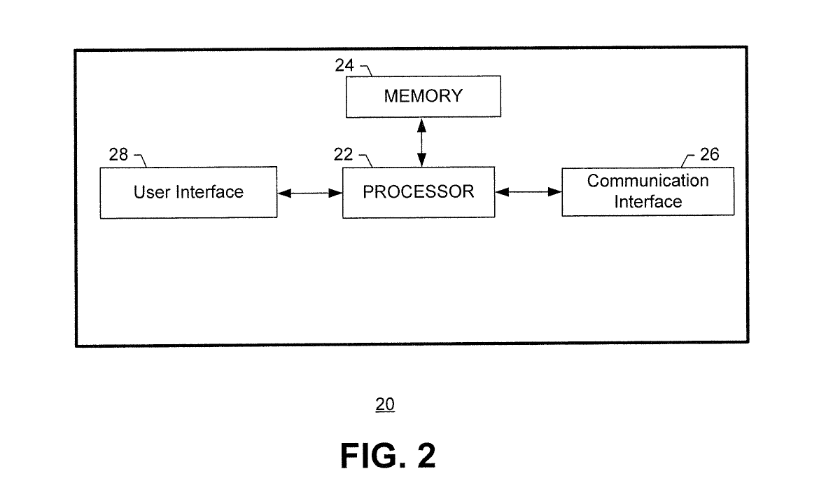

Regardless of the type of device that embodies the computing device 10, the computing device may include or be associated with an apparatus 20 as shown in FIG. 2. In this regard, the apparatus may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

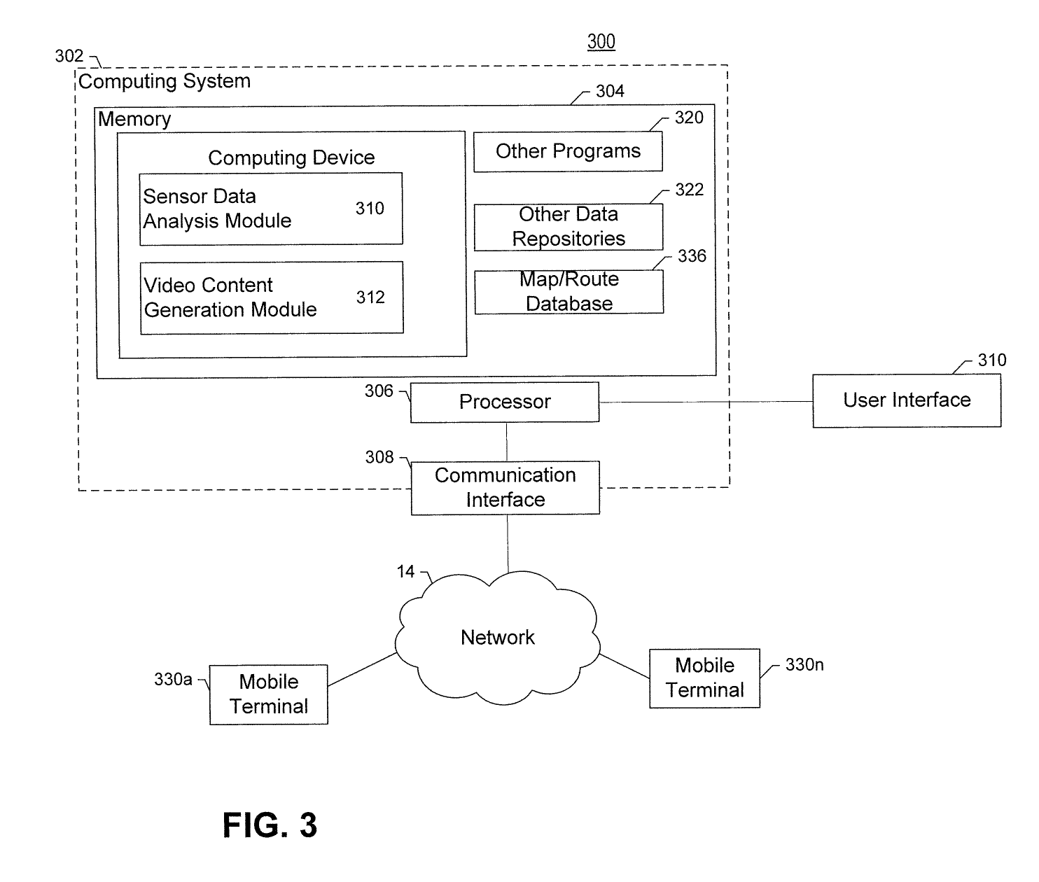

FIG. 3 is an example block diagram of an example computing system 300 for practicing embodiments of an automated transit route derivation system 302. In particular, FIG. 3 shows a system 300 that may be utilized to implement a computing system 302 used by for example a video editing service. Note that one or more general purpose or special purpose computing systems/devices may be used to implement the system 302. In addition, the system 302 may comprise one or more distinct computing systems/devices and may span distributed locations. Furthermore, each block shown may represent one or more such blocks as appropriate to a specific embodiment or may be combined with other blocks. For example, in some embodiments the system 302 may contain a sensor data analysis module 310, a video content generation module 312 or a combination thereof. In other example embodiments, the sensor data analysis module 310 and/or the video content generation module 312 may be configured to operate on separate systems (e.g. a mobile terminal and a remote server, multiple remote servers and/or the like). For example, the sensor data analysis module 310 and/or the video content generation module 312 may be configured to operate on a mobile terminal. Also, system 302 may be implemented in software, hardware, firmware, or in some combination to achieve the capabilities described herein.

While the system 302 may be employed, for example, by a mobile terminal 10, stand-alone system (e.g. remote server), it should be noted that the components, devices or elements described below may not be mandatory and thus some may be omitted in certain embodiments. Additionally, some embodiments may include further or different components, devices or elements beyond those shown and described herein.

In the embodiment shown, system 302 comprises a computer memory (“memory”) 304, one or more processors 306 (e.g. processing circuitry) and a communications interface 308. The computing device(s) are shown residing in memory 304. In other embodiments, some portion of the contents, some or all of the components of the system 302 may be stored on and/or transmitted over other computer-readable media. The components of the system 302 preferably execute on one or more processors 306 and are configured to receive and analyze sensor data, determine from which mobile terminal(s) to use video data form, and generate video content. Other code or programs 320 (e.g., an administrative interface, a Web server, and the like) and potentially other data repositories, such as data repository 322, also reside in the memory 304, and preferably execute on processor 306. Of note, one or more of the components in FIG. 3 may not be present in any specific implementation.

In a typical embodiment, as described above, the system 302 may include a sensor data analysis module 310, a video content generation module 312 or a combination thereof. The sensor data analysis module 310, the video content generation module 312 or a combination thereof may perform functions such as those outlined in FIG. 1. The system 302 interacts via the network 14 via a communications interface 308 with (1) mobile terminals 330, (2) localization device equipped bus(es) 332 and/or (3) local transit system servers 334. The network 14 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. In this regard, the communications interface 308 may be capable of operating with one or more air interface standards, communication protocols, modulation types, access types, and/or the like. More particularly, the system 302, the communications interface 308 or the like may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

In an example embodiment, components/modules of the system 302 may be implemented using standard programming techniques. For example, the system 302 may be implemented as a “native” executable running on the processor 306, along with one or more static or dynamic libraries. In other embodiments, the system 302 may be implemented as instructions processed by a virtual machine that executes as one of the other programs 320. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the system 302, can be made available by standard mechanisms such as through C, C++, C#, and Java APIs; libraries for accessing files, databases, or other data repositories; through languages such as XML; or through Web servers, FTP servers, or other types of servers providing access to stored data. A data store may also be included and it may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the system 302 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Some or all of the system components and data structures may also be stored as a web application, “app”, or any HTML5 or JavaScript™ application, such as a computer software application that is coded in a browser-supported programming language (such as JavaScript™) combined with a browser-rendered markup language like HTML5, reliant on a common web browser to render the application executable. The opening of a web page or “app” may be performed by a web browser on a user's mobile communications device 10. An HTML5 or JavaScript™ “app” allows web page script to contact a server 12, such as those shown in FIG. 1, for storing and retrieving data without the need to re-download an entire web page. Some or all of the system components and data structures may also be stored as a privileged web application or privileged web app. A privileged web app is a piece of web content that may have been verified by, for example, means of an app store or stores or may have obtained or downloaded from a source that is trusted source. A trusted source may provide a privileged web app that may be enabled to override the default power settings. Such computer program products may also take other forms in other embodiments. Accordingly, embodiments of this disclosure may be practiced with other computer system configurations.

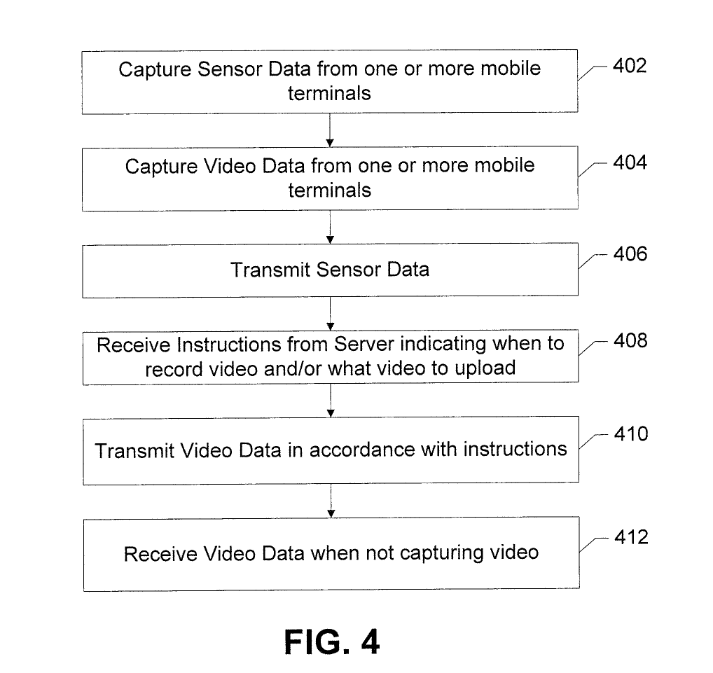

FIGS. 4, 5, and 6 illustrate example flowcharts of the example operations performed by a method, apparatus and computer program product in accordance with an embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 4, 5, and 6, when executed, convert a computer or processing circuitry into a particular machine configured to perform an example embodiment of the present invention. Accordingly, the operations of FIGS. 4, 5, and 6 define an algorithm for configuring a computer or processing to perform an example embodiment. In some cases, a general purpose computer may be provided with an instance of the processor which performs the algorithms of FIGS. 4, 5, and 6 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

In one example embodiment, a method, apparatus and/or computer program product may be provided as a video streaming service for following action (e.g., sports races along a track or road) seamlessly. Analysis of sensor data from mobile phones capturing video streams may be used to determine (1) which mobile terminal (e.g., phone(s)) are currently capturing and/or delivering an interesting video stream; (2) calculating time of arrival estimates of interesting targets (e.g., rally cars) to users further down the route; and (3) time for filling the gaps without available live footage with other content (e.g., slow motion instant replay clips). As a result, a seamless video broadcast may be delivered to all of the users following the race. The seamless video broadcast may comprise video stream of one of the users capturing currently moving objects, or, replays of different angles capturing a previous interesting object in such a case where nothing interesting is happening currently.

FIG. 4 is an example flowchart illustrating a method of operating an example mobile terminal, performed in accordance with an embodiment of the present invention. Specifically FIG. 4 shows an example method for capturing, transmitting, and/or displaying video.

As shown in block 402 of FIG. 4, the apparatus 20 embodied by the computing device 10 may then therefore be configured to capture sensor data. The apparatus embodied by the computing device therefore includes means, such as the processor 22, the communication interface 26 or the like, for causing capture of sensor data. In one embodiment, an apparatus, such as mobile terminal, may be equipped with one or more of a compass, a location system, and accelerometer. Sensor data may be captured from one or more of a compass, GPS location system, and accelerometer. In another embodiment, a mobile terminal may be equipped with a gyroscope for capturing sensor data. In another embodiment, a mobile terminal may be equipped with a microphone for capturing sensor data.

As shown in block 404 of FIG. 4, the apparatus 20 embodied by the computing device 10 may then therefore be configured to capture video data. The apparatus embodied by the computing device therefore includes means, such as the processor 22, the communication interface 26 or the like, for causing capture of video data. In one embodiment, video data may also include corresponding audio data captured with a microphone on or near the apparatus.

As shown in block 406 of FIG. 4, the apparatus 20 embodied by the computing device 10 may then therefore be configured to transmit data. The apparatus embodied by the computing device therefore includes means, such as the processor 22, the communication interface 26 or the like, for causing transmission of data. In one embodiment, the apparatus may be configured to upstream sensor data.

As shown in block 408 of FIG. 4, the apparatus 20 embodied by the computing device 10 may then therefore be configured to receive data comprising one or more instructions. The apparatus embodied by the computing device therefore includes means, such as the processor 22, the communication interface 26 or the like, for causing reception of data comprising one or more instructions. In one embodiment, the apparatus may be configured to monitor network transmissions, wait for a transmission or a signal comprising an instruction to transmit video data. The instruction may comprise information detailing what video data to transmit, such as a time frame to transmit video data. The instruction may additionally or alternatively comprise a buffer (e.g., +/−5 seconds) period to transmit video from. In one embodiment, an instruction may comprise a quality of video to transmit. The apparatus may also be configured to display an instruction or otherwise signal to a user when it is time to start recording video.

As shown in block 410 of FIG. 4, the apparatus 20 embodied by the computing device 10 may then therefore be configured to transmit video data. The apparatus embodied by the computing device therefore includes means, such as the processor 22, the communication interface 26 or the like, for causing transmission of video data. In one embodiment, the apparatus may be configured to transmit video data in accordance with the one or more instructions received in block 408.

As shown in block 412 of FIG. 4, the apparatus 20 embodied by the computing device 10 may therefore be configured to receive data. The apparatus embodied by the computing device therefore includes means, such as the processor 22, the communication interface 26 or the like, for causing reception of data. In one embodiment, the apparatus 20 may be configured to receive video data and/or display streaming video data. In one embodiment, the video data may be displayed when the apparatus is not recording.

In one example embodiment, the apparatus may display video showing a race. Additionally or alternatively, in one embodiment, the apparatus may be configured to record and/or transmit sensor data. When the action is nearing a place where the apparatus may be able to record video of the action, the apparatus may be configured to receive information comprising an instruction to stop showing video, switch from a video display mode to a video record mode, and/or display a notice to a user to start recording. The apparatus may then be configured to record video of the action and transmit the video at the time of recording and/or at a time after. The apparatus may be configured to stop recording either in accordance with the instructions that were received or in response to a user switching a mode of the apparatus. The apparatus may then display video data again while the action is elsewhere.

In one example embodiment, User B may be positioned in the middle of the rally track. User B may be holding his device horizontally (with a main camera facing down), and the mobile device may be displaying a video stream from the start grid provided by user A at the start grid. At the same time, user C may be positioned 800 meters further down the track from user B. A race car leaves from the start grid. User B is viewing the captured feed by user A from the starting grid with his mobile device. The server may estimate how long it will take for the car to arrive at user B's location, based on an estimated speed of the car and the length of the route between the locations of user A and B. When the race car is approaching user B, the device shows a notification to start capturing video and user B raises the device and points it to the race track. This gesture of raising the mobile device may switch it automatically from the video viewing more to video camera capture mode. After the car has passed user B's position, he lowers the device and it may automatically switch back to receive live feed from other people. While waiting the car to arrive to user C's position, the video feed shows an instant replay of the previous clip and automatically switches to live feed provided by user C when the car is approaching.

In a real-life situation there can be one or multiple people covering the same positions of the track and intelligent logic can be used to select the most representative clip automatically and/or show other secondary clips as instant replay to the user in other locations.

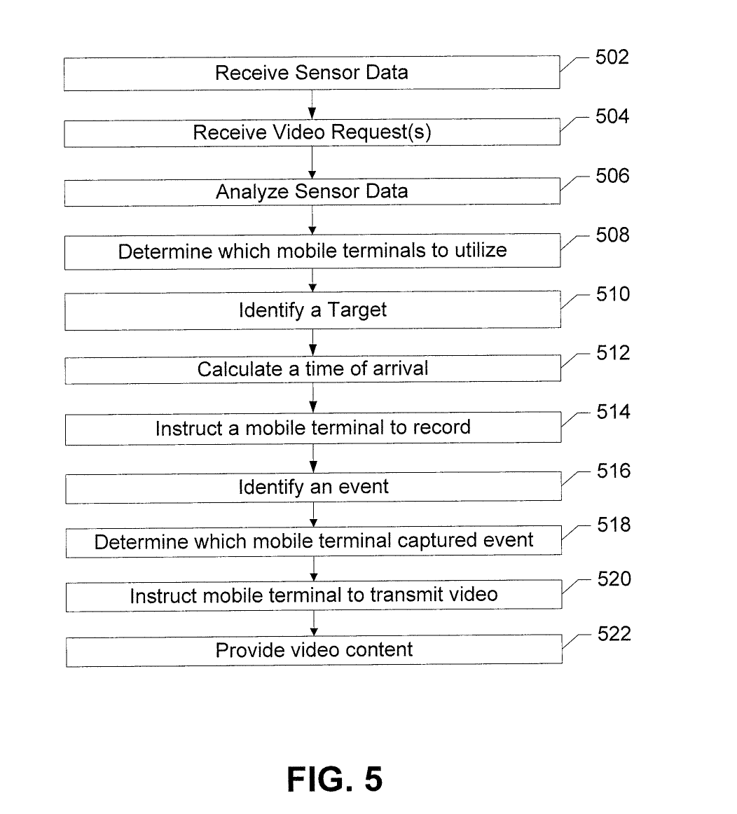

FIG. 5 is an example flowchart illustrating a method of operating an example computing system performed in accordance with an embodiment of the present invention. Specifically, FIG. 5 may show an example embodiment related to the analysis of sensor data to determine which mobile terminal(s) to utilize in generating video content of a target and/or event.

As shown in block 502 of FIG. 5, the apparatus 20 embodied by the computing device 10 may therefore be configured to receive sensor data from one or more mobile terminals. The apparatus embodied by the computing device therefore includes means, such as the processor 22, the communication interface 26 or the like, for causing reception of sensor data from one or more mobile terminals.

As shown in block 504 of FIG. 5, the apparatus 20 embodied by the computing device 10 may therefore be configured to receive a video request from one or more mobile terminals. The apparatus embodied by the computing device therefore includes means, such as the processor 22, the communication interface 26 or the like, for causing reception of a video request from one or more mobile terminals.

As shown in block 506 of FIG. 5, the apparatus 20 embodied by the computing device 10 may therefore be configured to analyze sensor data. The apparatus embodied by the computing device therefore includes means, such as the processor 22, the communication interface 26 or the like, for causing analysis of the sensor data.

As shown in block 508 of FIG. 5, the apparatus 20 embodied by the computing device 10 may therefore be configured to determine which of the one or more terminals may be positioned to capture video data. The apparatus embodied by the computing device therefore includes means, such as the processor 22, the communication interface 26 or the like, for determining which of the one or more terminals may be positioned to capture video data. The video data that may be captured may be a specific target such as a race car or the like, or a specific event, like a pass, a crash or the like.

As shown in block 510 of FIG. 5, the apparatus 20 embodied by the computing device 10 may therefore be configured to identify a target. The apparatus embodied by the computing device therefore includes means, such as the processor 22, the communication interface 26 or the like, for causing identification of a target.

As shown in block 512 of FIG. 5, the apparatus 20 embodied by the computing device 10 may therefore be configured to calculate a time of arrival. The apparatus embodied by the computing device therefore includes means, such as the processor 22, the communication interface 26 or the like, for calculating a time or arrival.

As shown in block 514 of FIG. 5, the apparatus 20 embodied by the computing device 10 may therefore be configured to provide instructions to at least one mobile terminal positioned to capture video data of the target at the time of arrival. The apparatus embodied by the computing device therefore includes means, such as the processor 22, the communication interface 26 or the like, for provide instructions to at least one mobile terminal positioned to capture video data of the target at the time of arrival.

In one embodiment, the apparatus may be configured to provide video data of action. When the apparatus determines an event is occurring and/or has occurred, the apparatus may be configured to provide video data of the event.

In one embodiment, the apparatus may be configured to communicate time of arrival information to each of one or more mobile terminals positioned along a route, for example to a chain of such people located along a race track as pre-warning that the car is approaching. Additionally or alternatively, if the speed of car is known the apparatus may be configured to determine how long it will take before car approaches a next mobile terminal. The apparatus may update a time-of-arrival estimate and provide the estimate for display in the mobile terminal while the mobile terminal is not capturing, for example, while the user is viewing video content captured by a different mobile terminal.

As such, as shown in block 516 of FIG. 5, the apparatus 20 embodied by the computing device 10 may therefore be configured to identify an event. The apparatus embodied by the computing device therefore includes means, such as the processor 22, the communication interface 26 or the like, for causing identification of an event.

In one embodiment, to obtain more detailed information from the users regarding an event, the apparatus may be configured to receive indications of the type of event which is happening. The apparatus may be configured to determine or assign event priorities utilized for selecting instant replay clip. For example, in a rally event, the events might include “car passing by”, “car overtaking another”, “car crash”, “car approaching”, “car starting”, or “car crossing finish line”. Here for example, one event such as car overtaking or car crash may be assigned a higher priority than other events.

In one embodiment, when an event is detected in video content from a user, the video stream may be switched to the video data from the mobile terminal filming the event. The angle may be from the user who indicated that the event happened, or from another user who is currently filming near the location. If several events are happening at the same time, the view is switched to a video stream which has been captured near the event which has the highest priority. For example, if at the same time the server receives the events “car starting” and “car crash”, a view of the car crash may be shown.

As shown in block 518 of FIG. 5, the apparatus 20 embodied by the computing device 10 may therefore be configured to determine which of one or more mobile terminals captured the event. The apparatus embodied by the computing device therefore includes means, such as the processor 22, the communication interface 26 or the like, for causing determination of which of one or more mobile terminals captured the event.

In one embodiment, based on uploaded sensor data, the apparatus may be configured to determine where interesting events are currently happening or have happened. In one embodiment, the apparatus is configured to detect at least one of multiple users starting to capture at the same time near a location, or one or more users performing a quick sideways motion to either direction. The apparatus may then be configured to determine that the target or other interesting objects (rally cars) are currently being captured by or able to be captured by one or more mobile terminals. Mobile terminals may be configured to transmit information indicating when a capturing or recording mode is performed. For example, detecting multiple users starting to capture near a location may be done such that the mobile terminals communicate information indicating when they start video capture. Along with that information, or in a separate data packet, the server receives the mobile terminal's location (e.g., as latitude/longitude coordinates). In one embodiment, if a predetermined number of video capturing events happen within an area, then the service may determine that something interesting is happening. In one embodiment, a threshold may be utilized, for example, at least two users starting to capture within a 50 meter radius. If such an occurrence happens, the service may determine to switch to one of the camera angles of the users who just started to capture.

In one embodiment, the apparatus may receive the compass orientation data (e.g., with respect to the magnetic north) and their associated timestamps from one or more mobile terminals. Based on this data, the apparatus may determine whether a sideways motion is performed. In another embodiment, audio data, for example, sound from vehicle engine, may be captured with the device microphone and analyzed, for example to confirm that it is the car or motorcycle that is being captured.

In one embodiment, in a first mode, when the mobile terminal is oriented display up, a video stream may be viewed. In this mode, the display may show a pre-warning of approaching targets overlaid on top of the video stream. For example, the distance and direction of the approaching target may be shown on the device display. A countdown may be displayed to suggest the user when the object arrives and user may start filming it. In a second mode, when the device is oriented side down with the display & viewfinder facing the user, the video capture may be automatically started. In one embodiment, flipping the orientation, captured by the accelerometer sensor, toggles between these two modes.

Also, switching from landscape to portrait mode may be used to trigger a split screen presentation between the captured viewfinder image and video stream received from the service

As shown in block 520 of FIG. 5, the apparatus 20 embodied by the computing device 10 may therefore be configured to provide instruction to the mobile terminal to transmit or upload the video data of the event. The apparatus embodied by the computing device therefore includes means, such as the processor 22, the communication interface 26 or the like, for causing instructions to be provided to the mobile terminal to transmit or upload the video data of the event.

As shown in block 522 of FIG. 5, the apparatus 20 embodied by the computing device 10 may therefore be configured to cause generation of video content comprising video data captured by at least one mobile terminal. The apparatus embodied by the computing device therefore includes means, such as the processor 22, the communication interface 26 or the like, for causing generation of video content comprising video data captured by at least one mobile terminal.

The video content may comprise video data captured by at least one mobile terminal. In one embodiment, the video content may comprise at least the video data captured by a mobile terminal during the particular time frame related to an estimated time of arrival of a target. Additionally or alternatively, the video content may comprise video data of one or more events.

In one embodiment, the video content may comprise live video data during one or more periods of time when a mobile terminal is able to capture the target and video data of one or more events during one or more periods of time when a mobile terminal is not capturing the target.

In one embodiment, a crowdsourced video streaming service may be used with a professional broadcasting service. For example, the system may be configured to determine or assign labels (e.g., a skill of a cameraman or a quality of the captured video) to the mobile terminals capturing video. The system may prioritize video content from particular mobile terminals capturing for example, video from professional video cameramen along the route. The system may monitor events occurring along the route, and if, for example, a car crash happens, switch to video of the event. In one embodiment, amateur footage of events not captured by the professional cameramen may be interleaved with the professional content, providing additional value and a way for the users to participate in the broadcast.

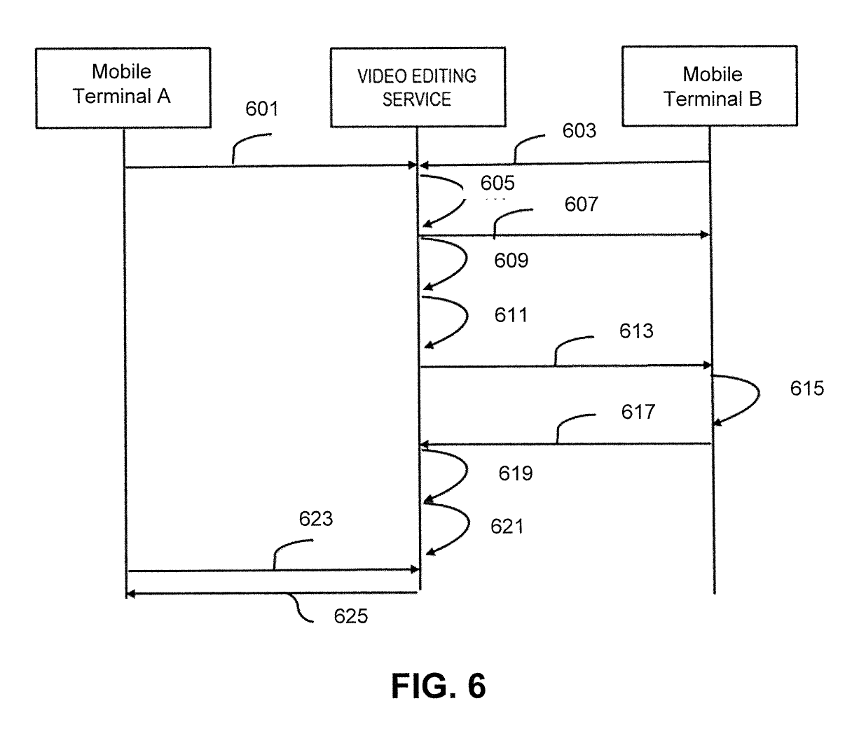

FIG. 6 is an example embodiment showing a method of use in accordance with an embodiment of the present invention. Specifically, FIG. 6 may show an example embodiment related to live capture and display of video utilizing multiple mobile terminals.

FIG. 6 depicts an example of the operations between mobile terminals (using for example, a mobile terminal 20) and a service related to the use case. In step 601, mobile terminal A may be providing a video stream to the service. In addition to the video stream, mobile terminal A may be providing location data and other sensor data captured by the sensors in the mobile terminal. In step 603, mobile terminal B is requesting a video stream from the service and providing its location data. In step 605, the service creates a video stream to be delivered to users. In this case, it is created from the video stream from mobile terminal A. In step 607, the service provides the video stream to mobile terminal B, allowing mobile terminal B to experience the feed captured by mobile terminal A. In step 609, the service determines that a race car has passed the mobile terminal A based on the location and sensor data received from mobile terminal A. It also estimates the speed of the car. In step 611, the service determines, based on the estimated speed, route data (obtained e.g. from a map module, not shown), and the location of mobile terminal B, how long it will take for the car to reach user B. In step 613, the service sends a notification to mobile terminal B to start capturing video. In step 615, the user of mobile terminal B raises his device to point to the race track and starts capturing video. In step 617, mobile terminal B provides video feed, location, and sensor data to the server. In step 619, the service determines that a race car has passed mobile terminal B and that the video stream should be switched to the stream provided by mobile terminal B. In step 621 the service creates a video stream from the video stream provided by mobile terminal B. In step 623 the user of mobile terminal A turns the device horizontally, which stops the capture of video and signals the server that mobile terminal A wishes to receive video feed. In step 625, the service provides the video stream (now created from mobile terminal B's feed) to mobile terminal A.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving sensor data from one or more mobile terminals;
analyzing the sensor data to determine whether to utilize video data captured by or able to be captured by at least one mobile terminal; and
causing transmission of an instruction to the mobile terminal to capture video during a particular time frame; and
causing generation of video content comprising video data captured by at least one mobile terminal, wherein the generated video content comprises at least the video data captured during the particular time frame.

2. The method according to claim 1, wherein analyzing the sensor data to determine whether to utilize video content associated with the sensor data, comprises:
identifying a target;
calculating a time of arrival of the target to a position in which a mobile terminal is able to capture video data of the target, the position determined by sensor data; and
wherein the particular time frame is related to the time of arrival of the target.

3. The method according to claim 1, wherein analyzing the sensor data to determine whether to utilize video content associated with the sensor data, comprises:
identifying an event; and
determining at least one mobile terminal that captured the event based on the sensor data; and
causing transmission of an instruction to the at least one mobile terminal to transmit video data related to the event during a particular time frame related to the time of arrival of the target,
wherein the generated video content comprises video data of the event.

4. The method according to claims 1,
wherein the video content is a real time video broadcast, comprising live or near live data during one or more periods of time when a mobile terminal is able to capture the target and previously recorded video data of one or more events during one or more periods of time when a mobile terminal is not capturing the target.

5. The method according to claim 1, wherein the sensor data comprises at least one of compass data, Global Positioning System (GPS) location data, and accelerometer data, gyroscope data, and audio data.

6. A method for use in a mobile terminal comprising:
causing capture of sensor data;
causing transmission of sensor data; and
causing display of a video stream;
receiving instructions indicating when to switch from a viewing mode to a capture mode; and
causing transmission of captured video data.

7. The method of claim 6 wherein the instructions comprise a time of arrival estimate, wherein the method further comprises, causing display of a warning in advance of switching from the viewing mode to the capture mode.

8. The method of claim 6 further comprising:
providing a signal indicating a manual switch from a viewing mode to a capture mode to be utilized in event detection.

9. An apparatus comprising at least one processor and at least one memory including computer program code, the at least one memory and the computer program code configured to, with the processor, cause the apparatus to at least:
receive sensor data from one or more mobile terminals;
analyze the sensor data to determine whether to utilize video data captured by or able to be captured by at least one mobile terminal; and
cause transmission of an instruction to the mobile terminal to capture video during a particular time frame; and
cause generation of video content comprising video data captured by at least one mobile terminal, wherein the generated video content comprises at least the video data captured during the particular time frame.

10. The apparatus according to claim 9, wherein analyzing the sensor data to determine whether to utilize video content associated with the sensor data, comprises:
identifying a target;
calculating a time of arrival of the target to a position in which a mobile terminal is able to capture video data of the target, the position determined by sensor data; and
wherein the particular time frame is related to the time of arrival of the target.

11. The apparatus according to claim 9, wherein analyzing the sensor data to determine whether to utilize video content associated with the sensor data, comprises:
identifying a target;
calculating a time of arrival of the target to a position in which a mobile terminal is able to capture video data of the target, the position determined by sensor data; and
wherein the particular time frame is related to the time of arrival of the target.

12. The apparatus according to claim 9, wherein the video content is a real time video broadcast, comprising live or near live data during one or more periods of time when a mobile terminal is able to capture the target and previously recorded video data of one or more events during one or more periods of time when a mobile terminal is not capturing the target.

13. The apparatus according to claim 9, wherein the sensor data comprises at least one of compass data, Global Positioning System (GPS) location data, and accelerometer data, gyroscope data, and audio data.

14. An apparatus comprising at least one processor and at least one memory including computer program code, the at least one memory and the computer program code configured to, with the processor, cause the apparatus to at least:
cause capture of sensor data;
cause transmission of sensor data; and
cause display of a video stream;
receive instructions indicating when to switch from a viewing mode to a capture mode; and
cause transmission of captured video data.

15. The apparatus according to claim 14, wherein the instructions comprise a time of arrival estimate, wherein the method further comprises, causing display of a warning in advance of switching from the viewing mode to the capture mode.

16. The apparatus according to claim 14, wherein the at least one memory and the computer program code are further configured to, with the processor, cause the apparatus to:
provide a signal indicating a manual switch from a viewing mode to a capture mode to be utilized in event detection

17. A terminal apparatus, comprising a processor and a video display, the terminal apparatus configured for:
capturing video data; and displaying video data,
the terminal apparatus comprising at least a video capturing mode; and a video viewing mode,
wherein a mode is changed based on a position of the terminal apparatus.

18. The terminal apparatus according to claim 17, the terminal apparatus configured for transmitting video data,
wherein the video capturing mode is configured for transmitting video data.

19. The terminal apparatus according to claim 17, the terminal apparatus configured for receiving video data,
wherein the video viewing mode is configured for receiving video data.

20. The terminal apparatus according to claim 17, the terminal apparatus configured for capturing sensor data;
transmitting the sensor data; and
receiving information indicating a time for switching to the video capturing mode based on the sensor data.
